(19) United States
(12) Patent Application Publication
(10) Pub. No.: US 2011/0231434 A1
(43) Pub. Date: Sep. 22, 2011

(54) Information management apparatus

(75) Inventors: Yasuhiro Tabata, Kanagawa (JP); Takashi Yano, Tokyo (JP); Katsuyuki Kaji, Tokyo (JP); Kenta Nozaki, Tokyo (JP)

(73) Assignee: Ricoh Company, Limited, Tokyo (JP)

(21) Appl. No.: 13/064,133

(22) Filed: Mar. 8, 2011

(30) Foreign Application Priority Data
Mar. 17, 2010 (JP) 2010-061565
Dec. 20, 2010 (JP) 2010-283672

(51) Int. Cl. G06F 17/30

(52) U.S. Cl. 707/769; 707/825; 707/E17.005; 707/E17.014

(57) ABSTRACT

An information management apparatus managing information on avatars in the metaverse, includes: a static information acquisition unit which acquires static information of each of the avatars; a dynamic information acquisition unit which acquires dynamic information corresponding to behavior of each of the avatars; and an avatar information storage unit which stores therein the static information and the dynamic information in association with each of the avatars.

### CROSS-REFERENCE TO RELATED APPLICATIONS

The present application claims priority to and incorporates by reference the entire contents of Japanese Patent Application No. 2010-061565 filed in Japan on Mar. 17, 2010 and Japanese Patent Application No. 2010-283672 filed in Japan on Dec. 20, 2010.

### BACKGROUND OF THE INVENTION

1. Field of the Invention

The present invention relates to an apparatus collecting and analyzing the behavioral histories or scheduled behavior of an avatar in a three-dimensional virtual space and an apparatus using the analyzed data for marketing.

2. Description of the Related Art

These days, virtual realty based on a computer graphic technology has been used in various fields. In particular, there have emerged sites sharing a three-dimensional virtual space (referred to as metaverse) constructed on a network by a plurality of users. In the metaverse world, avatars that are the incarnations of the users are present to perform various activities. They do not merely enter the metaverse with a sense of a game, but they perform activities for business in the metaverse.

The business in the metaverse take form of, for example, building guidance, viewing, real estate guidance, house presentation, clothes simulation, fitting of clothing, a simulated experiment, a virtual museum, language education, a virtual exhibition, simulation of assembly and disassembly, a trial use of product, an on-line purchase of product, an advertisement system, a virtual experience of evacuation, or the like over various fields. Some of the businesses have already put into practical use.

It goes without saying that, at the time of product development, it is important to know needs of consumers. Therefore, as general methods, surveys have been carried out with respect to the customers, or exhibitions or the like have been held to find out user's preference and interest. However, such methods require considerable amounts of labor, cost, and time. In particular, to give an exhibition, a high cost is needed due to a rental fee during a period from exhibition hall preparation up to the date of exhibition, personnel expenses, and the like.

Therefore, Japanese Patent Application Laid-open No. 2004-234054 or Japanese Patent Application Laid-open No. 2006-155230 discloses a virtual exhibition held in the metaverse. According to the former, there is an advantage in that it is possible to effectively search for the exhibition item of user's interest among a plurality of exhibition items exhibited in the exhibition hall and it enables users to listen to the description on the search items through the presentations. In addition, it is introduced that the manipulation information associated with searching or selection of exhibition items, which indicates the preference of the participants in the virtual exhibition, can be obtained because such information is recorded as a log.

In addition, Japanese Patent Application Laid-open No. 2005-100053 discloses that, when advertisements are posted in or ornaments are given to the virtual space, information such as attributes of avatars expressing interests in the advertisements or ornaments, a number of times viewed by the avatars, a time during which the advertisements or ornaments are viewed by the avatars, and comments on the advertisements or the ornaments are acquired, and the information is used as marketing information. More specifically, information on sight of men and women with respect to a player of a football match in video is collected. This information is used as marketing information for more effective use of advertisements with respect to men and women.

However, in the methods disclosed in Japanese Patent Application Laid-open No. 2004-234054 and Japanese Patent Application Laid-open No. 2006-155230, although each product can be ranked among the entire exhibition products based on the interests expressed by the avatars, any other information cannot be obtained. Furthermore, the method disclosed in Japanese Patent Application Laid-open No. 2005-100053 does not directly relate to product development and sales methods.

### SUMMARY OF THE INVENTION

It is an object of the present invention to at least partially solve the problems in the conventional technology.

According to an aspect of the present invention, there is provided an information management apparatus managing information on avatars in the metaverse, including: a static information acquisition unit which acquires static information of each of the avatars; a dynamic information acquisition unit which acquires dynamic information corresponding to behavior of each of the avatars; and an avatar information storage unit which stores therein the static information and the dynamic information in association with each of the avatars.

According to another aspect of the present invention, there is provided an information management apparatus including: a static information acquisition unit which acquires static information of each of avatars visited a reception of a site provided in a specific island in metaverse; a dynamic information acquisition unit which acquires dynamic information of each of the avatars active in the site; an avatar information storage unit which stores the static information and the dynamic information in association with each of the avatars; a search unit which performs searching with a specific word or phrase included in the static information or the dynamic information as a key; and a display unit which displays a result of the searching by the search unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a configuration of an entire system for implementing an embodiment;

FIG. 2 is a view illustrating an office in a three-dimensional virtual space in the embodiment;

FIG. 3 is a view illustrating one scene of a three-dimensional virtual space office;

FIG. 4 is a view illustrating a configuration of a private object DB;

FIG. 5 is a view illustrating an ID card of a corporate avatar;

FIG. 6 is a view for explaining communication in a virtual office;

FIG. 7 is a view illustrating a metaverse address book;

FIG. 8 is an enlarged view illustrating a message column according to an embodiment;

FIG. 9 is a flowchart of registration of a corporate avatar according to the embodiment;

FIG. 10 is a table of records (schedule) of behavior of an avatar A;

FIG. 11 is a view for explaining a virtual exhibition hall of company X;

FIG. 12 is a control block diagram of acquiring and storing static information and dynamic information;

FIG. 13 is a table of list of dynamic information received by a third storage unit;

FIG. 14 is a flowchart of generation of an invitation card;

FIG. 15 is a view for explaining a generated invitation card;

FIG. 16 is a graph of time stayed in an exhibition hall X;

FIG. 17 is a graph of time at which avatar the avatar A accessed each exhibition item;

FIG. 18 is a graph of access time for each exhibition item in the exhibition hall X;

FIG. 19 is a view illustrating an example of a search screen enabling a search for static data, dynamic data, and semi-dynamic data of an avatar; and

FIG. 20 is a view illustrating a search result list table.

### DETAILED DESCRIPTION OF THE PREFERRED EMBODIMENTS

Hereinafter, an information management apparatus according to an embodiment of the present invention will be described in detail with reference to the accompanying drawings.

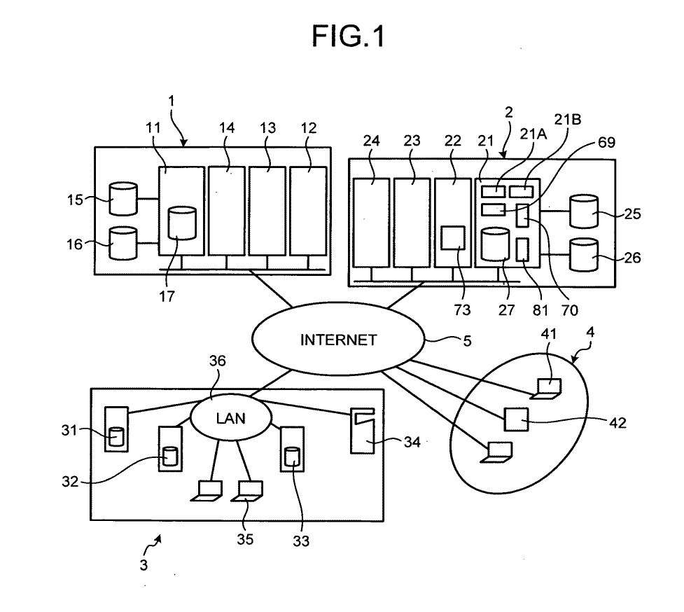

FIG. 1 is a view illustrating a configuration of an entire system for implementing an embodiment. The entire system is configured to include a public three-dimensional virtual space provider site 1, a private three-dimensional virtual space provider site 2, a client site 3, and a user site 4.

The public three-dimensional virtual space provider site 1 is a site administered by a provider who provides a three-dimensional virtual space to an arbitrary number of general public or subscribed users. For example, there is “Second Life” (registered trademark) administered by Linden Lab, U.S., or the like. The public three-dimensional virtual space provider site 1 is constructed with a public three-dimensional virtual space management server 11, a user connection management server 12, a user verification server 13, and a log management server 14.

The public three-dimensional virtual space management server 11 is externally connected to a public object DB (database) 15 and a public virtual space DB (database) 16. In addition, a three-dimensional virtual space 17 is constructed inside the public three-dimensional virtual space management server 11 by using data of the aforementioned two DBs.

The user connection management server 12 manages connections to user PCs so that the users may perform desired activities in the public three-dimensional virtual space.

The user verification server 13 of the user performs authentication with a user ID, a password, or the like to permit an access to the public three-dimensional virtual space.

The log management server 14 is configured so as to record the activities of the users in the public three-dimensional virtual space.

Next, the private three-dimensional virtual space provider site 2 is described. The private three-dimensional virtual space provider site 2 is a site administered by a provider who provides a private three-dimensional virtual space to subscribed client companies.

A client company can use the private three-dimensional virtual space as a space for an intra-bus, a customer relationship management (CRM), a supply chain management (SCM), or the like according to a contract.

The private three-dimensional virtual space provider site 2 is constructed with a private three-dimensional virtual space management server 21, a user connection management server 22, a user verification server 23, and a log management server 24.

The private three-dimensional virtual space management server 21 is externally connected to a private object DB (database) 25 and a private virtual space DB (database) 26. A three-dimensional virtual space 27 is constructed inside the private three-dimensional virtual space management server 21 by using data of the aforementioned two DBs.

The user connection management server 22 manages connections to user PCs so that the users can perform desired activities in the private three-dimensional virtual space.

The users include: internal users of the client company; and users (persons or companies) having transactions with the client company.

The user verification server 23 of the user performs authentication with a user ID, a password, or the like to permit an access to the private three-dimensional virtual space.

The log management server 24 is configured so as to record the activities of the user in the private three-dimensional virtual space.

Next, the client site 3 is described.

The client site 3 has an intranet of a company as a basic configuration. The client site 3 is constructed with an enterprise resource planning (ERP) server 31 as a core system, a document management server 32 as an information system, a groupware server 33 including mails, schedulers, or workflows, a multi-functional printer (MFP) 34, and a plurality of personal computers (PCs) 35 for users in the company. These components are connected to a local area network (LAN) 36. The LAN 36 is connected to the Internet 5.

Next, the user site 4 is described.

The user site 4 is constructed with a plurality of personal computers (PCs) 41, multi-functional printers 42, or the like of the unspecified number of the general public or the subscribed users with respect to the public three-dimensional virtual space provider or the private three-dimensional virtual space provider. The PCs 41 are connected to the Internet 5.

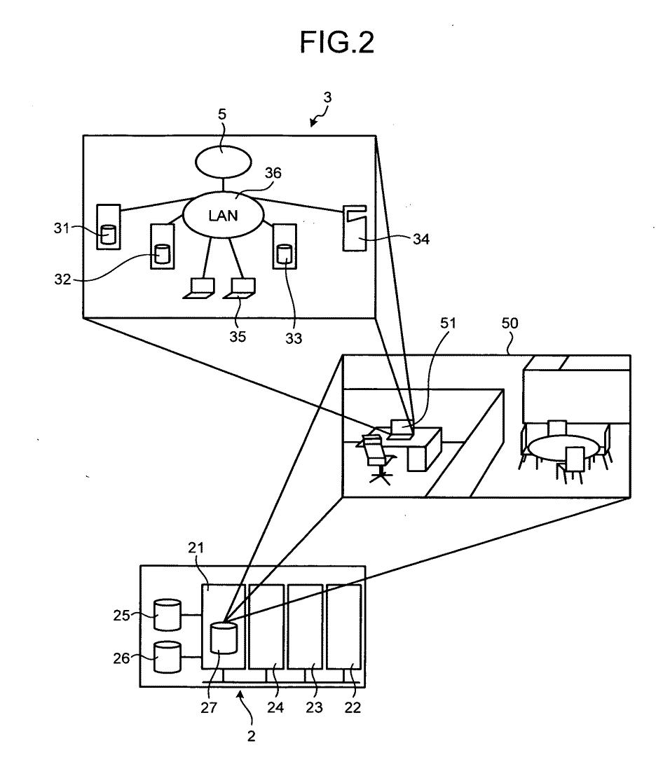

Next, a three-dimensional virtual space office 50 used in the embodiment is described with reference to FIG. 2.

The three-dimensional virtual space office 50 is configured in the three-dimensional virtual space 27 inside the private three-dimensional virtual space management server 21 of the private three-dimensional virtual space provider site 2. The three-dimensional virtual space office 50 is configured so that the avatars of the internal users of the client company or the avatars of the users having transactions with the client company perform tasks.

A personal computer (PC) 51 of the user in the three-dimensional virtual space office 50 is connected to the LAN 36 of the three-dimensional virtual space client site 3. Similarly to a client (not illustrated) in the real world, the three-dimensional virtual space client site 3 is constructed with the ERP server 31 as the core system, the document management server 32 as the information system, the groupware server 33 including mails, schedulers, or workflows, the multi-functional printer (MFP) 34, and a plurality of the personal computers (PCs) 35 for the users in the company. These components are connected to the LAN 36. The LAN 36 is connected to the Internet 5.

Both of the three-dimensional virtual space office 50 and the three-dimensional virtual space client site 3 are virtual.

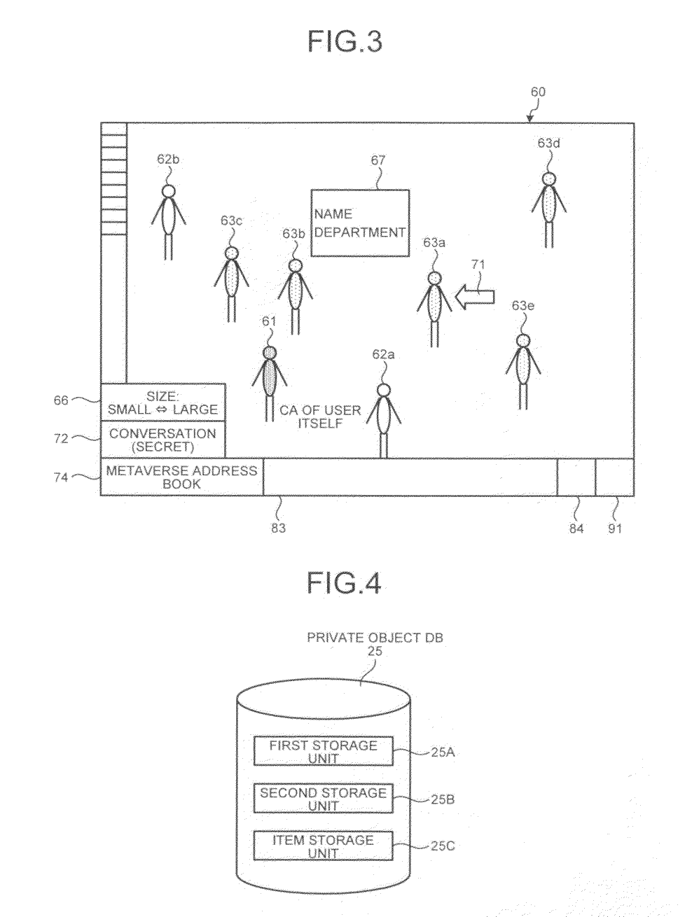

FIG. 3 illustrates one scene of a virtual office (or a virtual exhibition hall) 60 in the three-dimensional virtual space 27 inside the private three-dimensional virtual space management server 21 of the private three-dimensional virtual space provider site 2 according to the embodiment.

There are corporate avatars 61, 62 (62a, 62b), and 63 (63a to 63e). Although not denoted by reference symbols, all the elements representing human images are the corporate avatars. Information necessary for the corporate avatars are registered in the private object DB 25 connected to the private three-dimensional virtual space management server 21.

The virtual office 60 is reproduced as almost the same as a real office of the real world, in the virtual world. As illustrated in FIG. 4, the information on the virtual office 60 is stored in a first storage unit 25A in the private object DB 25. The virtual office information may be registered for each organization of the company. The organizations of the company are diagrammatically displayed in a tree, so that it may be possible to instantaneously jump to a desired organization. This organization tree information is also maintained in the first storage unit 25A. Similarly, in the case of the virtual exhibition hall, exhibition hall information is registered in advance, so that the virtual exhibition hall can be set in a specific island in the metaverse.

As for a method for registering a corporate avatar, the user enters into the private three-dimensional virtual space provider site 2 from the PC 41 of the user site 4 through the Internet. Under the user connection management server 22, a procedure for entering into the site 2 is controlled. For example, the user connection management server 22 performs operations of presenting rules for subscription to the site and agreeing to the rules, controls to exchange ID allocation and password registration for user registration with the user verification server 23, and control registration and reception of information necessary as the corporate avatar.

The static information for registration as the corporate avatar includes name, department (including company name), task, phone number, FAX number, and mail address in the real world. These are controlled as personal information and stored in a second storage unit 25B in the private object DB 25. If needed, the corporate avatar name can also be written. If the corporate avatar name is written, the corporate avatar name together with the aforementioned personal information is stored as a set in the second storage unit 25B.

When the corporate avatar is registered, the user can select an avatar, an appearance, a costume, or the like according to user's preference among predetermined items stored in an item storage unit 25C as performed in the aforementioned “Second Life” or the like. However, since the corporate avatar is not related to a game, an appearance of a man in woman's costume or an appearance which is too different from that of an actual appearance of a person is not permitted. Therefore, in order to approach more real behavior, more detailed personal information may be input. For example, the more detailed personal information includes age, gender, physique (slender, fat, and medium), height, skin color, or the like. By inputting these information, it is possible to perform automatic generation of the corporate avatar.

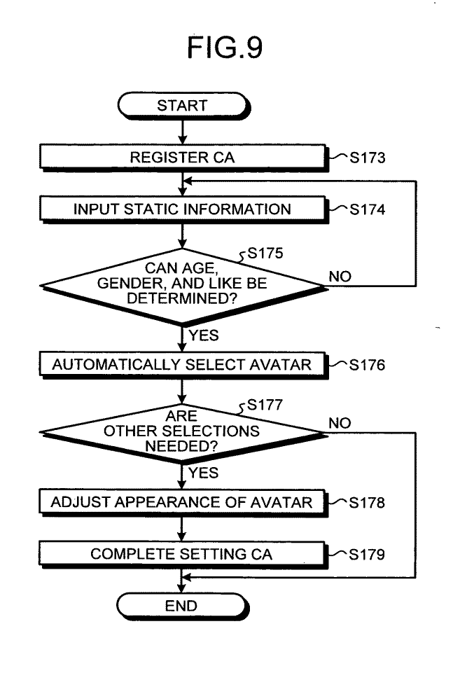

As illustrated in FIG. 4, a corporate avatar automatic generation unit 21A (see FIG. 1) in the private three-dimensional virtual space management server 21 is activated to select the item, which is considered to be the most suitable, from the item storage unit 25C based on the input personal information, so that the appearance of the corporate avatar is formed. In addition, fine tuning can be performed by the user. For example, when a plurality of choices are available within detailed types of the slender physique, the user can be allowed to select a substitutive item within the allowable range. It is preferable that the costume is selected by the user rather than automatically set. In the case where company uniform is obligatory, there is no choice. However, costumes stored in the item storage unit 25C can be selected. In the case of the corporate avatar, the items suitable for a general business casual are stored. Detailed registration procedure in the embodiment will be described in detail with reference to the flowchart of FIG. 9.

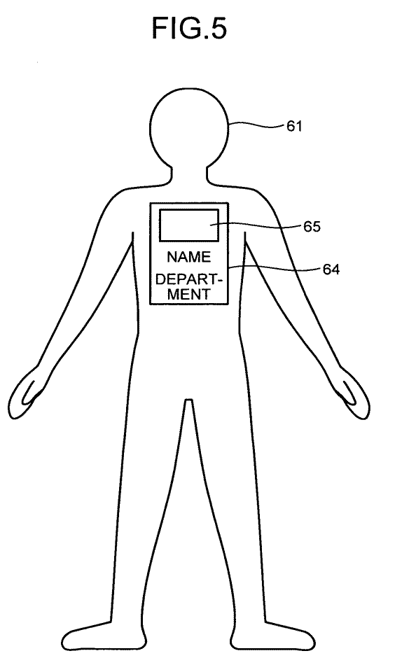

In addition, as illustrated in FIG. 5, the corporate avatar 61 wears an ID card 64 thereof on the body. Similarly to an ordinary office, name and department are displayed in the ID card 64. In addition, in the case it is obligated to register a picture of user's face, a picture of the face 65 is attached to the ID card 64. By a static information display unit 70 (see FIG. 1), the aforementioned information is transmitted with respect to a position of the ID card 64 attached to the corporate avatar, and the aforementioned information is displayed as the static information on a screen.

As illustrated in FIG. 3, when the entire organization is displayed, it is difficult to read the contents of the ID card 64 because the corporate avatars 61 to 63 are displayed with small sizes. In this case, the contents can be seen by performing a manipulation of enlarging the screen. Since there is a size increase/decrease button 66 in the lower left portion of FIG. 3, the button may be manipulated. In addition, if the corporate avatar 63a is right-clicked, only the information of the ID card 64 of the corporate avatar 63a can be enlarged and displayed in the vicinity thereof (information 67). In this example, only the name and department are exemplified, but a picture of the front face may also be displayed. Since other information is protected as personal information, other people are prohibited from unilaterally requesting for the information.

In addition, instead of the ID card 64 of the corporate avatar, the information on the corporate avatar may be attached as tag information. As described above, when the corporate avatar is right-clicked, the tag information may be displayed tag information 67 of FIG. 3.

If one of the corporate avatars left-clicks another corporate avatar, the corporate avatars can proceed into a conversation mode. In other words, one corporate avatar can make a real-time conversation with the corporate avatar of other person. It is natural to check what kind of character the avatar of other person is according to the aforementioned method before the conversation. This is performed with a conversation mode selection unit. Alternatively, as illustrated in FIG. 3, a cursor 71 is placed on the corporate avatar with whom the conversation is desired, and a conversation button 72 provided in the lower left portion of the screen is pushed, so that the user enters into the conversation mode. This is also performed with the conversation mode selection unit.

In addition, if the user enters into the conversation mode, the user makes conversations with the other person by using sound or keyboard. Sound or text information is transmitted in a two-way manner through a communication unit so as to make conversations with the other person in real time. A communication unit 73 is installed inside the user connection management server 22 (see FIG. 1).

Herein, determine on whether the real-time conversation with the corporate avatar is available is described. The corporate avatar 61 of the user himself/herself is a corporate avatar which is the incarnation of his/her own. In the embodiment, the corporate avatar may be, for example, in red. In the virtual office 60 illustrated in the screen of FIG. 3, there is a mixture of the corporate avatars 62a and 62b in white and the corporate avatars 63a to 63e in yellow. For example, a coloring unit 69 of the private three-dimensional virtual space management server 21 designates a displaying color of each of the corporate avatars to be displayed on the screen as described above. The corporate avatar in white represents the case where a user is away from a personal computer in the real world at the present time, so that the user cannot proceed into the conversation mode or the case where a user is in a situation where the user cannot make conversation with another person, so that the conversation mode is cut off. Naturally, in the case where a user goes out of the office or the user is not present in the company, the corporate avatar does not appear in the virtual office 60. In the case where the white corporate avatars 62a and 62b are erroneously left-clicked, a message “Right now, conversation is not available.” is configured to be displayed in the vicinity of the corporate avatar.

As described above, a dynamic information management unit 21B (see FIG. 1) manages which status the corporate avatar is in at the current time. In other words, the dynamic information management unit 21B manages the latest status of each of the corporate avatars based on the input information and the automatic determination. Here, the latest status of each of the corporate avatars includes: an active status in which a user is entered into the three-dimensional virtual space and active; a resting state in which the user is entered into the virtual space but the user is absent for a predetermined time (an arbitrarily settable time); and a conversation refusing state in which the user is entered into the virtual space but the user cannot make communication or refuses to communication.

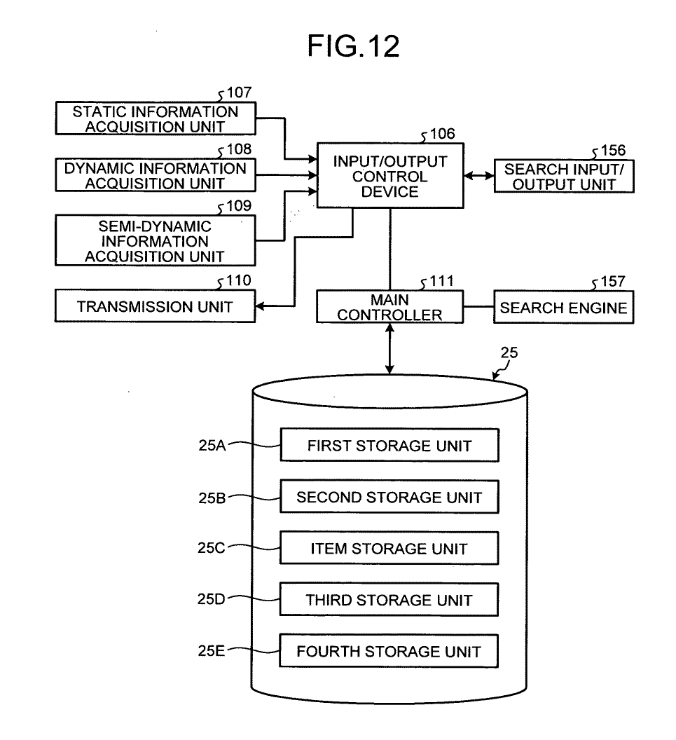

In addition, the dynamic information of the corporate avatar in the company indicating which island, district, village, or exhibition hall the corporate avatar has visited or when and which conference the corporate avatar has participated in, or the like is recorded in a predetermined template. In addition, as another example, location information indicating which exhibition item installed in which exhibition hall the corporate avatar has viewed (clicked) together with time information is logged and stored as the dynamic information. The dynamic information management unit 21B records the dynamic information of the corporate avatar, for example, in a third storage unit 25D inside the private object DB 25 (see FIG. 12).

Since the corporate avatars 63a to 63e in yellow represents the status in which the corporate avatars 63a to 63e are entered into the virtual world by manipulating the PCs, it is illustrated that the real-time conversation is available.

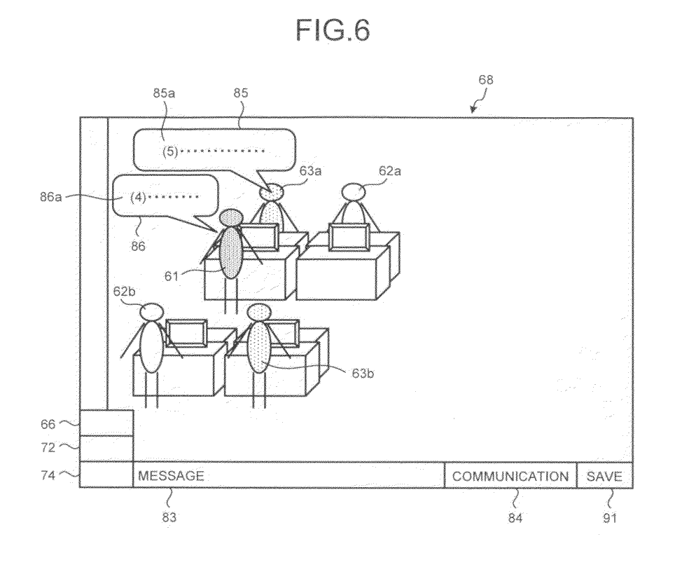

Although described later, in case the corporate avatar enters into the virtual office and performs tasks, if the button “HOME” (not illustrated) at a position of the screen is pushed, the corporate avatar may be allowed to jump to take its own seat. In other words, almost the same layout as that of an office in the real world is formed as a virtual office in the virtual world. The virtual office is the virtual office 50 of FIG. 1 or a virtual office 68 of FIG. 6. Each corporate avatar can designate its own seat at the time of the registration. The description of the manipulation will not be given.

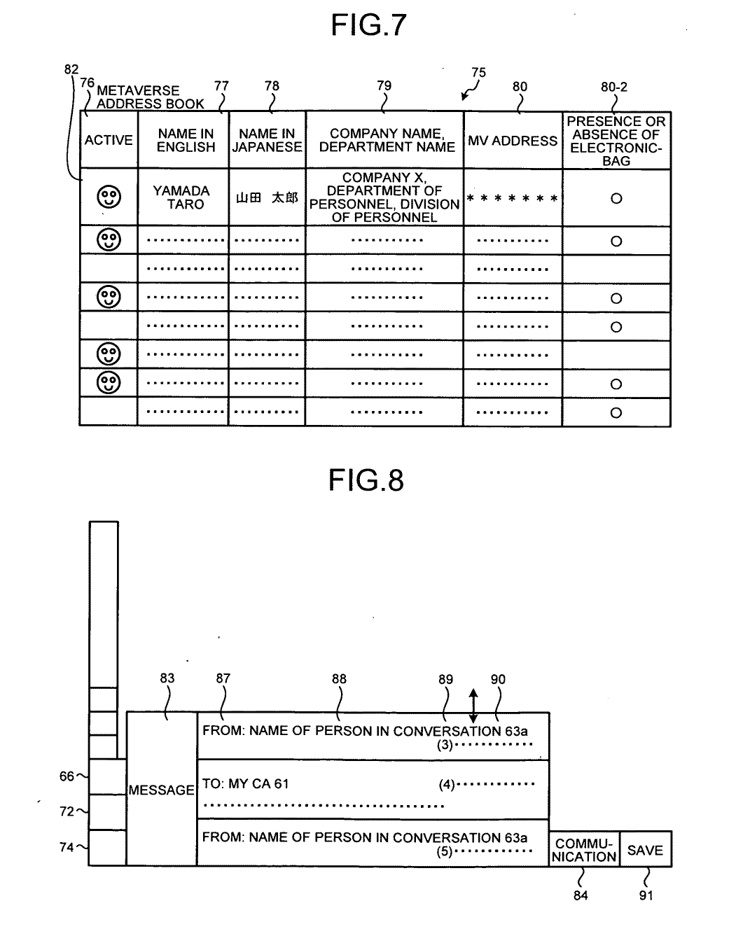

As illustrated in FIG. 7, the virtual office 60 illustrated in FIG. 3 illustrates one organization in a company named X. It is natural that only the corporate avatars of the company X can be entered into the company X. Similarly to the entrance to a company in the real world, permission or prohibition of the entrance into the virtual office 60 is determined at the entrance gate or the reception based on a combination of data (ID and password) registered in the user verification server 23. In this manner, even in the virtual office 60, security management is performed similarly to the real world.

The corporate avatars illustrated in FIG. 6 are colored in this manner. The corporate avatar 61 of the user is colored red; the corporate avatars 62a and 62b who are not in the conversation are colored in white; and the corporate avatars 63a and 63b who are in conversation available status are colored yellow. The coloring unit 69 is installed in the private three-dimensional virtual space management server 21 (see FIG. 1).

In the display screen illustrating the virtual offices 60 and 68, a metaverse address book button 74 calling for the metaverse address book (three-dimensional virtual space address book) is disposed at the lower left portion.

If the metaverse address book button 74 is selected and clicked with a mouse button, as illustrated in FIG. 7, a metaverse address list table 75 of the metaverse address book is displayed. The metaverse address list table 75 is configured to include an active column 76, a name in English 77, a name in Japanese 78, a company/department name 79, a metaverse (MV) address 80, and presence or absence of an electronic-bag 80-2. The metaverse address list table 75 is stored in an MV address storage unit 81 inside the private three-dimensional virtual space management server 21 illustrated in FIG. 1. In addition, although not illustrated in FIG. 7, an e-mail address, a corporate avatar name, a FAX number, a phone number, and the like used in the current real world are also stored in the metaverse address list table 75 of the MV address storage unit 81. It can be set in advance or at any time by the user which information is to be displayed on the screen of the metaverse address list table 75.

A face mark 82 displayed in the active column 76 is configured so as to be displayed corresponding to “active” in the information (active, on-vacation, non-participation, or the like) included in the aforementioned dynamic information management unit 21B. The other information items, that is, the name in English 77 to the presence or absence of the electronic-bag 80-2 are configured so as to be displayed based on the second storage unit 25B storing the static information.

The MV address storage unit 81 stores the address information of all the users who are subscribed in the private three-dimensional virtual space provider site 2 through contracts. In the three-dimensional virtual space client site 3, user-based MV address books may be stored in address information storage unit (not illustrated) inside the groupware server 33 or in a hard disk drive of the PC 35 of the client.

Similarly, in the public three-dimensional virtual space provider site 1, the MV address information is stored in a storage unit of the public three-dimensional virtual space management server 11.

In this manner, the MV address information of various types of the metaverse (three-dimensional virtual space) provider sites is shared, so that it is possible to implement communication between the three-dimensional virtual spaces. In addition, since the mail address in the current real world is designated from the three-dimensional virtual space, it is possible to perform communication. In addition, the MV address is designated from the current real world, so that it is possible to perform communication between the three-dimensional virtual space and the current real world.

In case where the corporate avatar is entered into the virtual office 60 and active, the face mark 82 is displayed in the active column 76 as illustrated. In case where the corporate avatar does not enter into the virtual office 60 in the virtual space or is not active, for example, in case where the corporate avatar is inactive or does not participate, the face mark 82 is not displayed. In case where a user desires to make a communication with a corporate avatar, the user can make a communication by selecting the avatar from the MV address book. In particular, in case where a user desires to make a real-time communication, the real-time communication can be established by selecting a corporate avatar attached with the face mark 82. In case where the face mark 82 is not attached to a corporate avatar, the user writes a message in a message column 83 disposed at the lower portion of the screens 60 and 68 and pushes a communication button 84 to send the message like a generally-used e-mail and to leave the message in a mail server of the other person.

Establishment of the real-time communication will be described more in detail. FIG. 6 is a view for explaining the communication in the virtual office.

With reference to FIG. 6, the real-time communication established between the corporate avatar 61 of the user and the corporate avatar 63a of the other person at the front seat in the virtual office 68 is described. The corporate avatar 63a may try to make a real-time communication. In this case, a message as illustrated in a speech balloon 85 is displayed in the vicinity of the corporate avatar 63a on the screen. Accordingly, if the corporate avatar 61 of the user makes a reply, a message as illustrated in a speech balloon 86 is displayed in the vicinity of the corporate avatar 61 of the user. Next, the messages may be exchanged repeatedly for plural times. If the massages are exchanged five times, the latest contents of the conversation between the two corporate avatars 61 and 63a are displayed in the speech balloons 85 and 86. In addition, orders of the exchanged conversations are indicated by reference numerals 85a and 86a at the head of the messages of the aforementioned speech balloons 85 and 86. The figure illustrates that the corporate avatar 61 of the user sends the fourth message and the corporate avatar 63a sends the fifth message as a reply thereof. Therefore, it can be understood that the next (sixth) message is its own message.

In addition, although the speech balloons 85 and 86 of the screen only display the latest messages of the corporate avatars, the message column 83 disposed at the lower portion of the screen is configured to display all of the exchanged messages as illustrated and enlarged in FIG. 8. The upper side of the message column 83 can be dragged upward to be extended by the mouse, so that a larger amount of the message information can be displayed. In the figure, although the three latest messages (3), (4), and (5) that are recently enlisted are displayed, all the messages from the first message can be viewed by further extending the upper side of the message column 83 upwards. The latest message is displayed in the lowest portion of the message column 83, and if the sixth message is created, the sixth message is displayed under the latest message. From the left-hand side of the message, a label “FROM” 87 is displayed and the name of the corporate avatar of the other person in conversation, which indicate the sender of the message, are displayed adjacent thereto. A name 88 of the corporate avatar 63a is displayed therein. On the right side thereof, numeral 89 indicating the order of the message is displayed, and on the right side of the numeral, a message 90 is displayed. In the case of a long message, the message is arranged in several lines.

When the conversation is finished and the entire conversation information is desired to be stored as record, the conversation information is stored in a communication recording unit 24a of the log management server 24 by pushing a save button 91 prepared on the right side of the communication button 84.

The conversation is displayed in the vicinity of the corporate avatar taking part in the conversation on the screen as described above, but the content of the conversation may not be desired to be revealed to other corporate avatars. In this case, if the conversation button 72 of FIG. 3 or FIG. 6 is pushed, it can be selected whether the secret setting is to be performed. In the case where the secret setting is selected, it may be arbitrarily set in advance whether speech balloons 85 and 86 are never displayed in the vicinity of the corporate avatars or the contents of the conversation are not displayed in the speech balloons. However, the message is displayed in the message column 83 prepared at the lower portion of the screen.

The procedure of a corporate avatar registration method will be described with reference to a flowchart of FIG. 9.

After the connection to the private three-dimensional virtual space provider site 2 is made, registration of the corporate avatar (CA) is made through a corporate avatar registration screen (not illustrated) (Step S173). As an input of the initial data, the static information on the corporate avatar (CA) is input (Step S174). For example, the following information on the corporate avatar (CA) is input. Examples of the input static information on the corporate avatar (CA) includes name, department (including company name), task, phone number, FAX number, mail address, metaverse address (in the case of including the static information of the other three-dimensional virtual space site), gender, age, physique, height, and skin color in the real world. For example, regarding an employee of a company X, “male, age 50, average physique, height of 170 cm, skin color of yellow” are input. Next, gender determination, age determination, physique determination, height determination, skin color determination, or the like are performed, and it is determined whether the determination can be finished (Step S175). When the determination cannot be finished because the information necessary for the determination is not input (No in Step S175), the message indicating that the missing information needs to be input is displayed on the input screen. Once the information such as age is input, since the information such as age is updated every year, the information does not need to be input again. In addition, a hair style, presence or absence of a mustache, presence or absence of glasses, physical characteristics, or the like may be input, so that more realistic appearance can be made. Therefore, in the virtual office, it may be possible to easily find the corporate avatar, with whom the user desires to make conversation, from the appearances similar to that of the real world.

When the determination is finished (Yes in Step S175), the avatar is automatically selected based on the input information (Step S176). The objects constituting the appearance of the avatar are recorded and stored in the private object DB 25 in FIG. 1. The appearance objects matching the above-mentioned information are automatically selected among stored objects, so that the appearance of the avatar is formed. Next, it is determined whether the other selections are needed (Step S177). If the formed appearance of the avatar is satisfactorily such that it is similar to the appearance of the user, it is determined that the other selections are not necessary according to a command of pushing a finish button or the like (No in Step S177), and the setting of the CA is completed (Step S179).

When the appearance is very much different from the user, when further adjustment is needed, or when the user desires to dress the avatar with clothes according to the user's preference, it is determined that the other selections are needed according to a command of the adjustment or the like (Yes in Step S177), and the tuning of the appearance of the avatar is performed (Step S178). At this time, the costume associated with business in the company can be freely selected and changed. Since the office is a virtual office, clothes or the like for business are prepared. If the appearance is adjusted, the setting of the CA is completed (Step S179). The set information of the appearance of the corporate avatar is newly registered in the private object DB 25.

Some other day, when the user logs into the same site by using its own ID and password, the registered appearance of the corporate avatar appears.

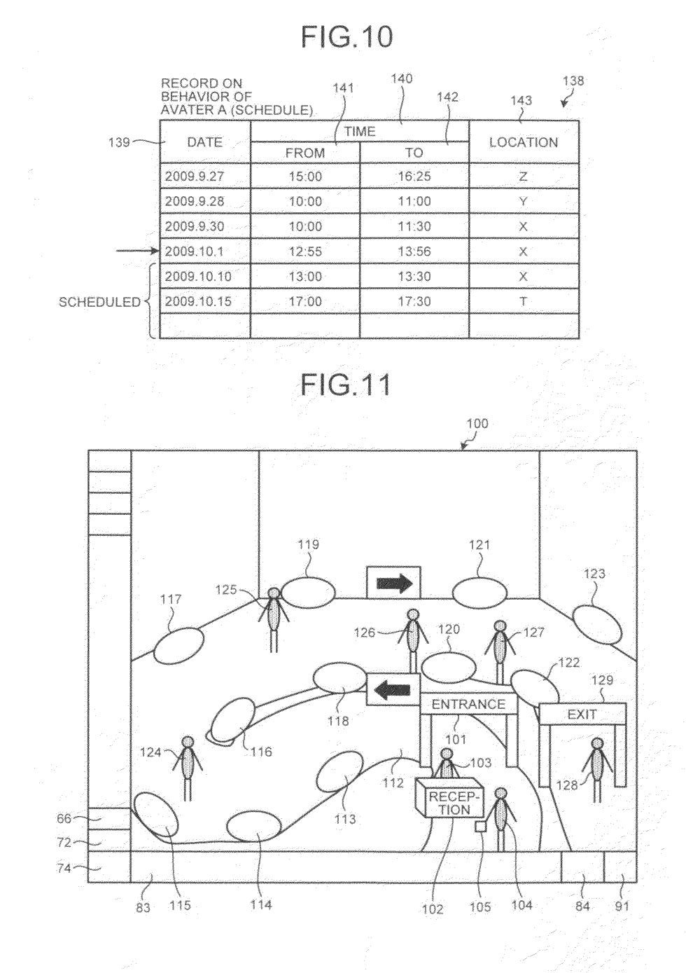

Next, a function of registering records (schedule) on behavior of an avatar will be described. FIG. 10 is a view illustrating the records (schedule) of behavior of the avatar A. An avatar behavior record (schedule) table 138 is provided with a date column 139, a time column 140 (FROM 141 and TO 142), and a location column 143. For convenience, Oct. 1, 2009 is set as the current date. Upper four lines of the table are registered as scheduled behavior of the passed. For example, the avatar A was scheduled to go to the location Z in the virtual space from 3:00 p.m. to 4:25 p.m. on Sep. 17, 2009. If the log of the dynamic information of the avatar A is not investigated, it cannot be known whether the avatar A actually went to the location at that time.

In addition, since all of the locations X, Y, Z, and T in the records (schedule) of behavior of the avatar A are towns or event places managed by the company X, the information o may be stored in a same fourth storage unit 25E (see FIG. 12). If the scheduled behavior in the feature is known, a strategy on what kind of guidance is appropriate can be made based on a relationship with the passed behavior log, that is, the dynamic information. Therefore, it is possible to perform one-to-one marketing dedicated to individual avatars.

### First Embodiment

A first embodiment will be described with reference to FIGS. 11 and 12. FIG. 11 is a view for explaining a virtual exhibition hall of company X. FIG. 12 is a control block diagram of acquiring and storing static information and dynamic information. A gate (entrance gate 101) of entrance of the exhibition hall is provided for a virtual exhibition hall 100 installed in the three-dimensional virtual space. A reception counter 102 of the exhibition hall is provided outside the entrance gate 101. In the reception counter 102, visitors are registered. At the reception counter 102, a reception avatar 103 of the host side is placed to perform a reception process for a visiting avatar 104. The visiting avatar 104 introduces him/herself to the reception avatar 103 or presents a virtual space business card 105, which can be used in the virtual space. In the virtual space business card 105, avatar name, name, company name, department, task, phone number, e-mail address, metaverse (MV) address, and the like are recorded as the static information. Therefore, by presenting the virtual space business card 105 to the reception avatar 103, the aforementioned static information is automatically acquired at the reception.

An input/output control unit 106 of FIG. 12 controls a static information acquisition unit 107, a dynamic information acquisition unit 108, and a semi-dynamic information acquisition unit 109. In addition, the input/output control unit 106 controls a transmission unit 110 for transmitting the avatar information in the private object DB 25 as an avatar information storage unit to an external portion. In other words, the presenting of the virtual space business card 105 by the visiting avatar 104 means that the user fetches the static information from the second storage unit 25B in the private object DB (avatar information storage unit) 25 in which the visiting avatar 104 is included, and transmits the information through the transmission unit 110.

On the contrary, the receiving of the virtual space business card 105 by the reception avatar 103 means that the static information transmitted through the transmission unit 110 is received through the static information acquisition unit 107. However, as described above, the address information of the avatar is included in the static information. Therefore, the acquisition unit for the address information becomes similar to the aforementioned static information acquisition unit. However, in the case where the address information needs to be acquired separately from the static information that is acquired by the static information acquisition unit, the address information acquisition unit needs to be separately prepared. In particular, since the activities in the metaverse are generally used based on the metaverse (MV) address, the e-mail address in the real world cannot be easily acquired without particular labor and effort. Therefore, at the reception counter in FIG. 11, the visiting avatar is asked if the visiting avatar can give the e-mail address in the real world, and under the agreement of the visiting avatar, the information is acquired.

The acquired static information is stored in the third storage unit 25D of the private object DB 25 by a main controller 111. In addition, at the reception, the visiting avatar is requested to provide additional static information for the purpose of marketing. Although not illustrated, a questionnaire sheet is presented from the reception avatar 103. The questionnaire sheet includes, for example, a list of gender, age, physique, height, skin color, nationality, hair style, presence or absence of a mustache, presence or absence of glasses, favorite color, favorite pet animal, hobby, or the like. Although all the avatars need not reply, they are asked for giving a help as possible as they can. The questionnaire is displayed on the screen in a pop-up manner, and if required contents are input, the information is received by the static information acquisition unit 107 in FIG. 12 to be recorded as the information on the visiting avatar in the third storage unit 25D.

In the virtual exhibition hall 100, if the avatar passes through the entrance gate 101, the avatar can see exhibition items 113 to 123 exhibited along a passage 112. If an exhibition item is clicked, the explanation on the exhibition item is given by text and/or sound. While providing the description on the exhibition item, when the visiting avatar expresses no interest to the exhibition item, the description is no more given by text or sound upon the avatar leaves the exhibition item. At this time, the leaving is treated as the end of seeing the item. Instead of moving the avatar to leave from the front of the item, the user may manipulate a stop action with respect to a control panel (not shown) of the screen.

A visiting avatar 124 is listening to the voice description in front of the exhibition item 115. An avatar 125 is listening to the voice description about the exhibition item 119, and an avatar 126 is listening to the voice description of the exhibition item 120. An avatar 127 is moving from the exhibition item 120 to the exhibition item 122. A visiting avatar 128 finishes viewing the exhibition items and leaves the exhibition hall through an exit gate 129. When the exit gate 129 is passed by, counting of the time stayed by the visiting avatar 128 is ended.

The counting of the time stayed by the visiting avatar is started when the reception for the visiting avatar is started. The information is received by the dynamic information acquisition unit 108 in FIG. 12. The counting of time is ended when a visiting avatar passes through the exit gate 129. The counted time is stored as the dynamic information by the main controller 111 in the third storage unit 25D.

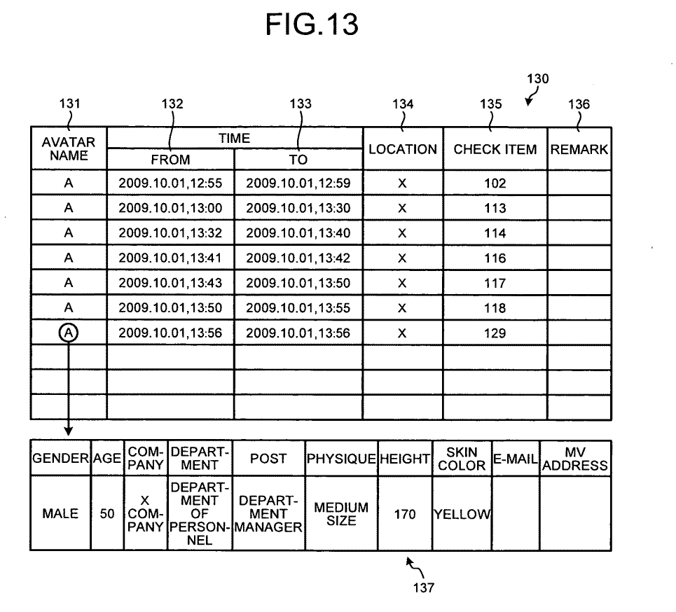

FIG. 13 is a table illustrating a list of the dynamic information received by the third storage unit. In a dynamic information list table 130, an avatar name column 131, a time FROM 132, a time TO 133, a location column 134, a check item column 135, and a remark column 136 are prepared in sequence from the left side. For the first row, an avatar A performs a reception process for four minutes from 12:55 p.m. to 12:59 p.m. on Oct. 1, 2009. In addition, with respect to the first exhibition item 113, the avatar A listens to product description or sees the product for a long time of 30 minutes. Next, the avatar A sees the exhibition item 114 for 8 minutes. The avatar A passes by the exhibition item 115 without seeing it. The avatar A sees the exhibition item 116 for a very short time of one minute. The avatar A sees the exhibition item 117 for 7 minutes. Finally, after the avatar A sees the exhibition item 118, the avatar A passes by the exhibition items 119 to 123 and goes out of the exhibition hall at 13:56 p.m. The log of the dynamic information described above is recorded in the third storage unit 25D. In addition, as illustrated in FIG. 13, at the reception, the avatar A leaves the static information illustrated in the figure as a reply to the questionnaire. Static information 137 such as gender and age is stored as information on the avatar A in the third storage unit 25D in a manner such that the static information and the dynamic information are associated with each other.

In this manner, for each visiting avatar, the static information and the dynamic information in the exhibition hall are stored in a correspondence manner in the private object DB 25.

In addition, action buttons prepared at the left portion and the lower portion of the screen illustrated in FIG. 11 are the same as those described with reference to FIGS. 3, 6, and 8, and thus, the description thereof is not repeated. It goes without saying that the visiting avatar appearing in the exhibition hall and the corporate avatar in FIG. 3 can also make conversations or the like through the same manipulation described above.

Hereinbefore, although the static information of the avatar is described to be acquired at the reception counter 102 in the exhibition hall X, it goes without saying that, when an external avatar visits a company, at the reception prepared at the entrance of the company X in FIG. 3, a receptionist receives a virtual space business card 105, so that the same static information of the visiting avatar as described can be acquired.

### Second Embodiment

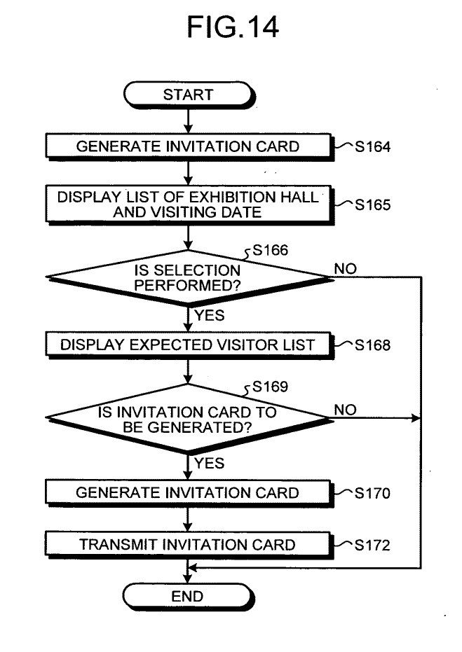

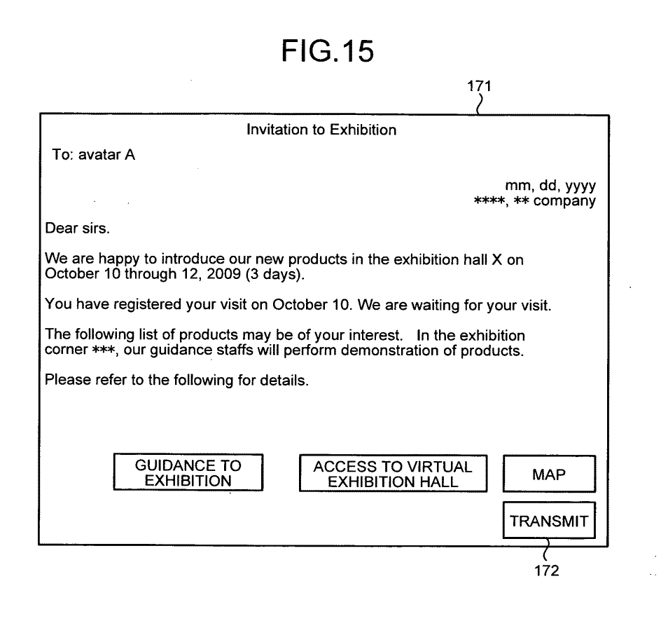

Next, a second embodiment will be described. In this embodiment, behavior schedule information is used as semi-dynamic information of a visiting avatar. As described in FIG. 10, as the schedule of behavior of the avatar A in the future from today (Oct. 1, 2009), a schedule of visiting a location X (exhibition hall X) on October 10 is recorded as information. In the company X as the host of the exhibition, if an invitation card generation program is selected from an input screen (not illustrated), exhibition halls, visiting dates, and the like are displayed. For example, if an exhibition hall X and a visiting date of Oct. 10, 2009 are selected, a list of avatars scheduled for visit is displayed. An invitation card generating button on the screen may be pushed. This is descried with reference to an invitation card generation flowchart of FIG. 14. First, an invitation card generation program is selected from an invitation card generating screen (Step S164). Therefore, a table of list of exhibition hall and scheduled visiting date is displayed (Step S165). Specific exhibition hall and visiting date are selected from the list table (Step S166). In the case where the selection is not performed (No in Step S166), the process is ended. In the case where the selection is performed (Yes in Step S166), Step S168 is performed. In Step S168, for example, if the exhibition hall X and the scheduled visiting date of Oct. 10, 2009 are selected, an expected visitor list is displayed. Next, it is determined whether an invitation card is to be generated (Step S169). When the invitation card is to be generated (Yes in Step S169), the invitation card for each of the visiting avatars is generated (Step S170). When the invitation card is not to be generated (No in Step S169), the process is ended. FIG. 15 illustrates a generated invitation card. A invitation card 171 is an invitation card for the avatar A. Next, similarly, the invitation cards for other visiting avatars are generated, and a transmission button 172 is pushed, the invitation card is transmitted to the e-mail address or the MV address (MV address) of the avatar A (Step S172 of FIG. 14). Since the e-mail address or the MV address (MV address) of the avatar A is stored as the static information of the avatar A, the address may be called and used.

### First Application Example

One application example (first application example) of the embodiment will be described. In the application example, the needs of the avatars serving as customers are statistically analyzed based on the static information, the dynamic information, and the semi-dynamic information of the avatars who visit the aforementioned exhibition hall. Several examples thereof are introduced.

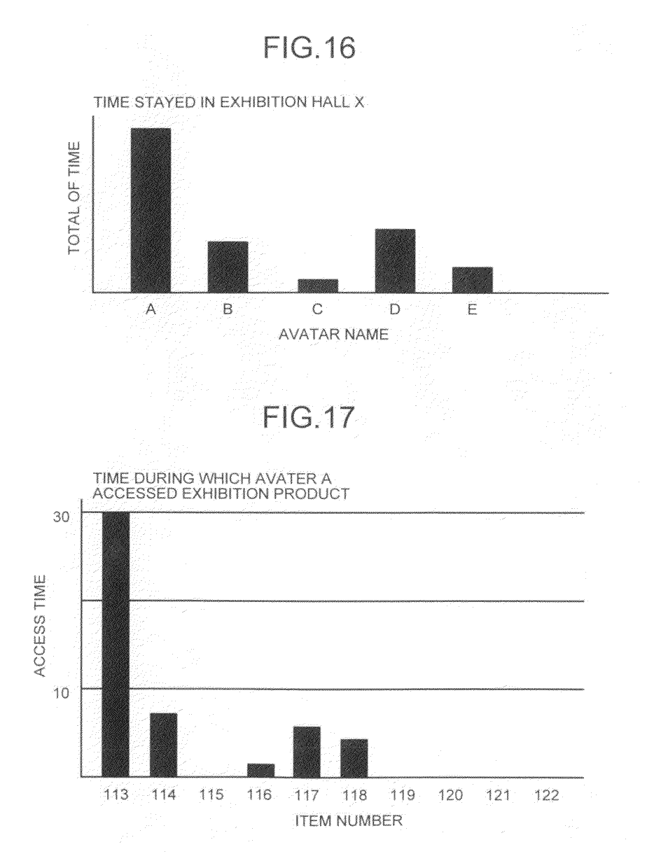

FIG. 16 illustrates time stayed in the exhibition hall by five avatars A to E. Avatar names are put on the horizontal axis, and the total time are put on the vertical axis. According to the graph, it can be understood that the time stayed by the avatar A is the longest and the time stayed by the avatar C is the shortest.

Now, it will be investigated which one of exhibition items the avatar A, who pays the most attention to this exhibition hall among the five avatars A to E, is most interested into. The searching method will be described later.

FIG. 17 illustrates access time of the avatar A with respect to the exhibition items. The avatar A listens to the voice description of the exhibition item 113 for a long time of 30 minutes. The avatar A nearly pays no attention to the exhibition items 115, and 119 to 122. The data can be displayed on the screen via the input/output control unit 106 through the transmission unit 110 by fetching the dynamic information of the avatar A in FIG. 13 from the third storage unit 25D through the main controller 111. With respect to the graph representation, the graph can be selected among a plurality of graph formats which are prepared in advance. A bar graph, a circular graph, a polygonal line graph, or the like may be freely displayed. The graph representation in Excel may be considered. Actually, the data are the same as the graph representation of the dynamic information of the avatar A in FIG. 13.

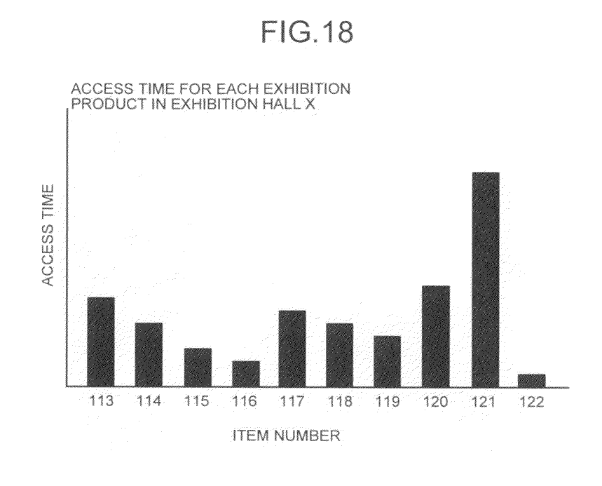

FIG. 18 is a graph illustrating access times with respect to exhibition items in an X exhibition hall. The horizontal axis refers to item numbers of exhibition items, and the vertical axis refers to the sums of access times. According to the graph, it can be determined which exhibition item is the most preferred and which exhibition item is the least preferred.

Although data or graphs based on the statistic data are exemplarily represented, various data can be extracted by using phrases of stored data as search keys. Hereinafter, the searching is described.

### Second Application Example

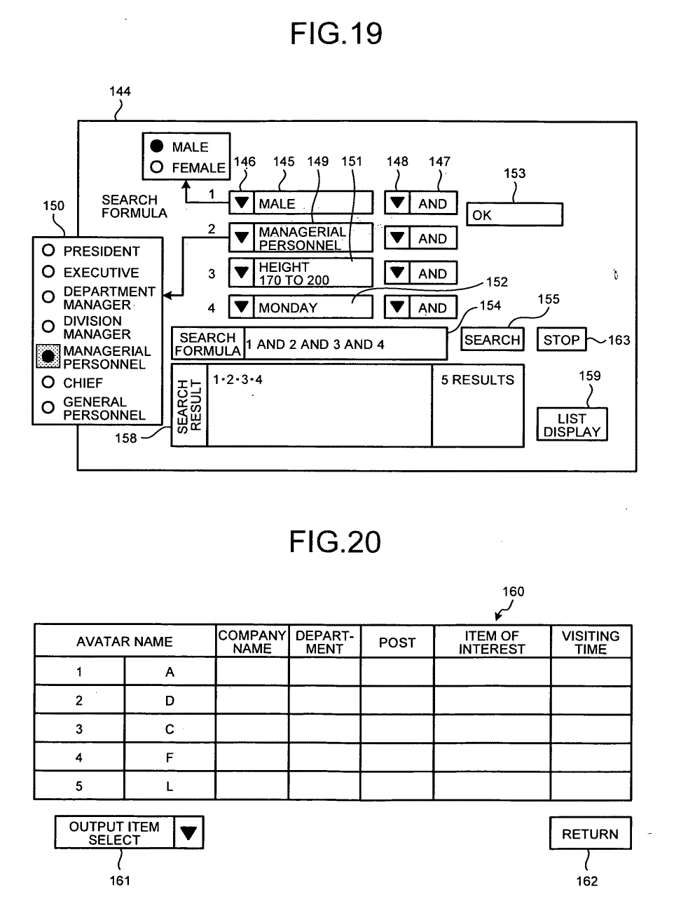

FIG. 19 is a view illustrating an example of a search screen for enabling a search for static data, dynamic data, and semi-dynamic data of an avatar as another application example (second application example) of the embodiment.

A search screen 144 is configured so that a search formula can be generated. For the convenience of description, it is configured so that four search items can be selected. If a button 146 in the left end of a first search item selection column 145 is clicked, a list of all the items which can be stored in a storage unit is displayed (not illustrated). For example, if the gender item is selected among the items, a screen where male or female can be selected in a pop-up manner appears as illustrated. At this time, if “male” is selected by a radio button, “male” is input in the phrase input column. In the case where a phrase is determined in advance, the phrase may be directly input by using the keyboard. As the right columns thereof, operator columns 147 capable of inputting operators are prepared.

Although an operator “AND” is preset, in the case where another operator is selected, if a left end button 148 is clicked, the other operators “OR,” “NOT,” and the like are displayed, so that an operator may be selected among the other operators. Since the item “task” is selected in a second search item selection column 149, details 150 of task are displayed on the screen. If the item “managerial personnel” is selected among the detailed tasks by the radio button, the phrase “managerial personnel” is input in the input column. In addition, similarly, the phrase “Height 170 to 200 (cm)” is input in a third input column 151, and the phrase “Monday” is input in a fourth input column 152. If a search formula checking button 153 of the upper right portion is pushed, the search formula for the four input items is displayed in a search formula column 154. It can be understood that the search formula is a condition of “AND” operation of the four input items. If the checking is finished, a search button 155 is pushed. Therefore, the input/output control unit 106 controls a search input/output unit 156 of FIG. 12, and a search engine 157 is driven through the main controller 111. The search engine 157 searches the second storage unit 25B, the third storage unit 25D, and the fourth storage unit 25E inside the private object DB 25. The data stored in the second to fourth storage unit connect the metaverse (MV) address in one-to-one correspondence with, for example, the avatars as a common key. In addition, if there are other key data in one-to-one correspondence, the key data may also be used. The data are transferred from the input/output control unit 106 to the search input/output unit 156, and the search formula and the number of results are displayed in a search result column 158 of the search screen 144. This figure illustrates that there are five results of data. When the five results are to be displayed, a list display button 159 prepared on the right side is pushed. Accordingly, as illustrated in FIG. 20, a search result list table 160 is displayed on the screen. Detailed information on five results satisfying the aforementioned search formula is displayed. Therefore, it may be possible to know the item of interest, the visiting time, and the like of the person who is a man with a height of from 170 to 200 cm as managerial personnel visiting the exhibition on Monday. The selection of output item is configured so that necessary output items can be selected among predetermined output items by pushing an output item select button 161. In order to return to the original search screen, a return button 162 may be pushed. In the case where the search on the search screen 144 is ended or stopped, the search screen is closed by pushing a stop button 163.

### Third Application Example

In a third Application example, a plurality of avatars which perform activities simultaneously are searched and analyzed from the dynamic information similar to that of FIG. 13. As illustrated in FIG. 12, the third storage unit 25D stores the location where each avatar exists and time when the avatar is present at the location. The avatars that are simultaneously present at the designated location, for example, in the time period from the designated starting time to the ending time can be extracted with reference to the dynamic information. More specifically, the avatars of which the time periods from the starting time (FROM) to the ending time (TO) overlap and of which the locations are the same can be extracted. In this manner, the information on the extracted avatar can be used for marketing with higher accuracy.

According to one aspect of the present invention, information analysis can be performed associating the information unique to the avatars with the behavior histories of the avatars. Thus, when the avatars are considered to be future customers, it may be possible to distinguish and classify the behavior histories of the avatars for each static information unique to the avatar, or the static information unique to the avatars for each behavior history. Through the analysis of the classification, very useful information analysis can be performed to determine what kind of product is to be developed or what kind of sales method for the product, so-called marketing, is to be used. In addition, since the three-dimensional virtual space is used, there is an advantage where it may be possible to find preferences or interests of users in countries over the world or of users in remote sites in a simple, inexpensive manner.

According to another aspect of the present invention, it may be possible to contrive a product sales strategy dedicated to a specific avatar by analyzing the behavior schedules of the avatars, and it may be possible to perform marketing activities with higher accuracy by putting advertisement or campaign dedicated to a specific avatar.

According to still another aspect of the present invention, a marketing person can search for target avatars satisfying a certain condition in a simple manner, so that the resulting information can be used for various uses.

According to still another aspect of the present invention, it may be possible to contrive a product sales strategy dedicated to a specific avatar by analyzing the behavior schedules of the avatars, and it may be possible to perform marketing activities with higher accuracy by putting advertisement or campaign dedicated to a specific avatar.

According to still another aspect of the present invention, since the information about the addresses of the avatars can be acquired, communication such as transmission of the information to the avatar from a host site may be performed.

According to still another aspect of the present invention, analysis of information can be performed by associating the information unique to each avatar with the behavior histories of the avatar. Thus, when the avatars are considered to be future customers, it may be possible to distinguish and classify the behavior histories for each static information unique to each avatar, or the static information unique to the avatars for each behavior history.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information management apparatus managing information on avatars in the metaverse, comprising:
a static information acquisition unit which acquires static information of each of the avatars;
a dynamic information acquisition unit which acquires dynamic information corresponding to behavior of each of the avatars; and
an avatar information storage unit which stores therein the static information and the dynamic information in association with each of the avatars.

2. The information management apparatus according to claim 1, further comprising a semi-dynamic information acquisition unit which acquires semi-dynamic information including scheduled behavior of at least one of the avatars in the past and in the feature.

3. The information management apparatus according to claim 1,
wherein the dynamic information includes a time period during which the avatar is in action and a location where the avatar is in action, and
wherein the information management apparatus further comprises an extraction unit which extracts some of the avatars each associated with the same location and with the overlapping time period from the avatar information storage unit, based on the dynamic information stored in the avatar information storage unit.

4. An information management apparatus comprising:
a static information acquisition unit which acquires static information of each of avatars visited a reception of a site provided in a specific island in metaverse;
a dynamic information acquisition unit which acquires dynamic information of each of the avatars active in the site;
an avatar information storage unit which stores the static information and the dynamic information in association with each of the avatars;
a search unit which performs searching with a specific word or phrase included in the static information or the dynamic information as a key; and
a display unit which displays a result of the searching by the search unit.

5. The information management apparatus according to claim 4, further comprising a semi-dynamic information acquisition unit which acquires semi-dynamic information including scheduled behavior of at least one of the avatars in the past and in the feature.

6. The information management apparatus according to claim 4, further comprising an address information acquisition unit which acquires address information of the avatars visited the reception of the site.

7. The information management apparatus according to claim 4,
wherein the dynamic information includes a time period during which the avatar is in action and a location where the avatar is in action, and
wherein the information management apparatus further comprises an extraction unit which extracts some of the avatars each associated with the same location and with the overlapping time period from the avatar information storage unit, based on the dynamic information stored in the avatar information storage unit.
